(19) United States
(12) Patent Application Publication
(10) Pub. No.: US 2024/0097994 A1
(43) Pub. Date: Mar. 21, 2024

(54) CONTROL SYSTEM, CONTROL METHOD AND DISPLAY APPARATUS INCLUDED IN CONTROL SYSTEM

(71) Applicant: Coretronic Projection (Kunshan) Corporation, Jiangsu (CN)

(72) Inventor: JIAHENG GUO, Jiangsu (CN)

(73) Assignee: Coretronic Projection (Kunshan) Corporation, Jiangsu (CN)

(21) Appl. No.: 18/471,306

(22) Filed: Sep. 21, 2023

(30) Foreign Application Priority Data
Sep. 21, 2022 (CN) 202211152351.5

(51) Int. Cl. H04L 41/22

(52) U.S. Cl. CPC H04L 41/22

(57) ABSTRACT

A control system, a control method, and a display apparatus included in a control system are provided. The control system includes a client apparatus and a display apparatus controlled by the client apparatus. The display apparatus is connected to a network and generates and displays an access object. The client apparatus is connected to the network, has a browser, captures the access object, and is connected to the display apparatus through the network according to information of the access object. The display apparatus provides an operation interface to the client apparatus through the network to display the operation interface in the browser of the client apparatus. The operation interface generates a control command based on operation performed therein by the client apparatus. The display apparatus receives the control command generated by the operation interface through the network, and performs an action according to the control command.

### CROSS-REFERENCE TO RELATED APPLICATION

This application claims the priority benefit of Chinese application no. 202211152351.5, filed on Sep. 21, 2022. The entirety of the above-mentioned patent application is hereby incorporated by reference herein and made a part of this specification.

### BACKGROUND

### Technical Field

The disclosure relates to a control mechanism. Particularly, the disclosure relates to a control system, a control method, and a display apparatus included in a control system.

### Description of Related Art

In recent years, in correspondence with the development of smart phones, smart terminal devices, and Internet of Things technology, a system for controlling a conventional projector has also been technically upgraded. Remotely controlling a smart projector by a smart phone may be divided into a direct communication mode and an indirect communication mode.

In the principle of the direct communication mode, a remote control application (APP) is installed on a smart phone, and a built-in infrared transmission module or a Bluetooth communication module of the smart phone is utilized to establish a communication channel with a built-in infrared receiving module or a Bluetooth module of a smart projector. A user operates the remote control APP to control the infrared transmission module or the Bluetooth module in the smart phone to send a command to the smart projector. The smart projector parses out the content of the command and performs a corresponding remote control action according to a preset communication protocol.

Comparatively, the indirect communication mode requires the help of a wireless routing network environment and a relay communication box to be realized. On the premise of access to a wireless local area network (WLAN), a smart phone is paired with the relay communication box by a remote control APP installed on the smart phone to access the same LAN environment. Such operation is generally realized using HyperText Transfer Protocol (HTTP). In the relay communication box, WiFi, an infrared module, and a Bluetooth module are integrated to convert signals.

However, different brands or different models of smart projectors may use different firmware. As a result, the above two communication modes require development of individual remote control APPs and communication protocols used on different operating systems for different brands or different models of projectors. Accordingly, regardless of the direct communication mode or the indirect communication mode, the technical requirements and the costs required for development and maintenance of software or hardware are relatively high. In addition, it is required for the user to install corresponding remote control APPs on the user's smart terminal device, which is also relatively complicated in use. If different brands or different models of projectors are required to be remotely controlled, the remote control APP corresponding to each projector is required to be installed on the smart terminal device, occupying the storage capacity of the smart terminal device.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides a control system, a control method, and a display apparatus included in a control system, in which a client apparatus can conveniently and quickly control the display apparatus without installing additional programs.

Other purposes and advantages of the disclosure may be further understood from the technical features disclosed by the embodiments of the disclosure.

To achieve one, some, or all of the above purposes or other purposes, a control system of an embodiment of the disclosure includes a display apparatus and a client apparatus. The display apparatus is connected to a network. The display apparatus is configured to generate and display an access object. The client apparatus is connected to the network and has a browser. The client apparatus is configured to capture the access object and be connected to the display apparatus through the network according to information of the access object. The display apparatus provides an operation interface to the client apparatus through the network, a browser of the client apparatus displays the operation interface, a control command is generated according to operation in the operation interface, and the control command is transmitted to the display apparatus through the network. The display apparatus performs an action according to the control command.

To achieve one, some, or all of the above purposes or other purposes, a control method of an embodiment of the disclosure is adapted to control a display apparatus by a client apparatus. The control method includes the following. A network is connected to and an access object is generated and displayed by the display apparatus. The access object is captured and the display apparatus is connected to through the network according to information of the access object by the client apparatus. An operation interface is provided by the display apparatus through the network to the client apparatus to display the operation interface in a browser of the client apparatus. Operation is performed on the operation interface by the client apparatus, such that the operation interface generates a control command based on the operation. The control command is received and an action of the display apparatus is performed according to the control command by the display apparatus through the network.

To achieve one, some, or all of the above purposes or other purposes, a display apparatus of an embodiment of the disclosure includes communication equipment and a processor. The communication equipment is configured to be connected to the network. The processor is coupled to the communication equipment. The processor is configured to: connect to a network by the communication equipment, and generate and display an access object representing an operation interface controlling the display apparatus; and receive a control command generated according to operation in the operation interface, and perform an action of the display apparatus according to the control command.

Based on the foregoing, the embodiments of the disclosure disclose that, with the access object provided by the display apparatus, the client apparatus can directly access the operation interface provided by the display apparatus. Accordingly, the client apparatus can conveniently and quickly control the display apparatus without installing additional programs.

Other objectives, features and advantages of the disclosure will be further understood from the further technological features disclosed by the embodiments of the disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a block diagram of a control system according to an embodiment of the disclosure.

FIG. 2A is a block diagram of a client apparatus according to an embodiment of the disclosure.

FIG. 2B is a block diagram of a display apparatus according to an embodiment of the disclosure.

FIG. 3 is a flowchart of a control method according to an embodiment of the disclosure.

FIG. 4 is a schematic diagram of the first application example of control realized by the client apparatus according to an embodiment of the disclosure.

FIG. 5 is a schematic diagram of the second application example of control realized by the client apparatus according to an embodiment of the disclosure.

FIG. 6 is a schematic diagram of the third application example of control realized by the client apparatus according to an embodiment of the disclosure.

FIG. 7 is a flowchart of the detailed internal actions of the display apparatus according to an embodiment of the disclosure.

FIG. 8 is a flowchart of the detailed internal actions of the client apparatus according to an embodiment of the disclosure.

FIG. 9 is a flowchart of interactions between the client apparatus and the display apparatus according to an embodiment of the disclosure.

FIG. 10 is a schematic diagram of overall actions of a control system according to an embodiment of the disclosure.

### DESCRIPTION OF THE EMBODIMENTS

The aforementioned and other technical contents, features, and effects of the disclosure will be clearly presented in the following detailed description of one of the preferred embodiments with reference to the drawings. The directional terms mentioned in the following embodiments, such as: up, down, left, right, front, back, or the like, are only referring to the directions of the accompanied drawings. Accordingly, the directional terms are used for describing instead of limiting the disclosure.

It is to be understood that other embodiment may be utilized and structural changes may be made without departing from the scope of the present disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

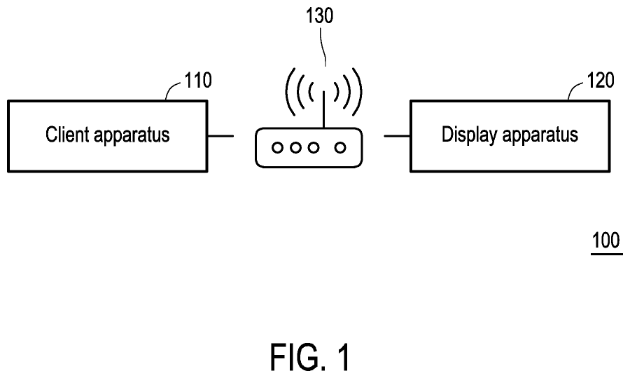

FIG. 1 is a block diagram of a control system according to an embodiment of the disclosure. With reference to FIG. 1, a control system 100 includes a client apparatus 110, a display apparatus 120, and a router 130. In this embodiment, a network is established by the router 130 for the client apparatus 110 and the display apparatus 120 to establish bidirectional communication under the environment of the same network for data exchange. For example, a local area network (LAN) is established by the router 130. The client apparatus 110 and the display apparatus 120 are connected to the LAN to establish bidirectional communication.

In an embodiment, a method of controlling the display apparatus 120 by the client apparatus 110 may be realized by adopting HTTP (HyperText Transfer Protocol) and WebSocket communication technologies. The WebSocket communication technology is used to establish connection between the client apparatus 110 and the display apparatus 120 for bidirectional data transmission. When the client apparatus 110 is connected to the network established by the router 130, the client apparatus 110 may realize communication and control operations by accessing an operation interface of the display apparatus 120.

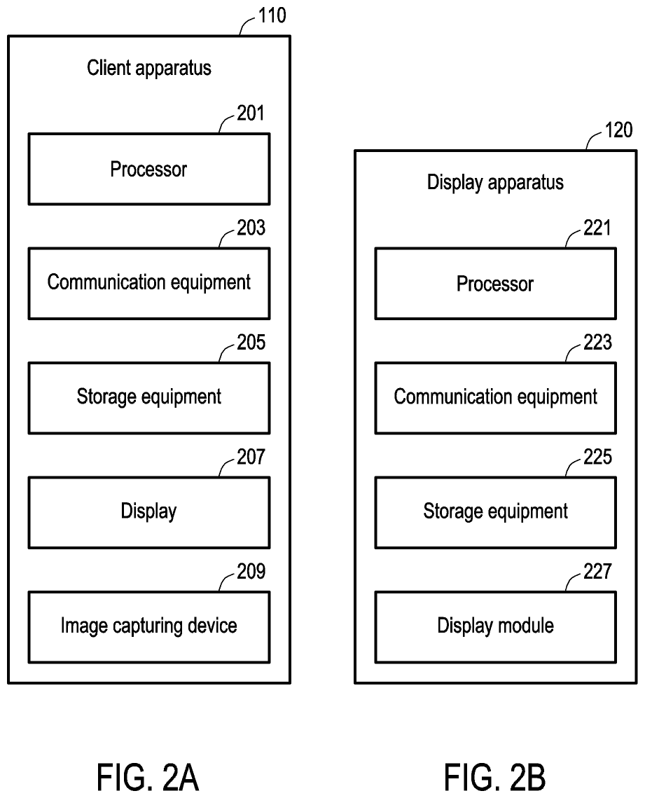

Both the client apparatus 110 and the display apparatus 120 are physical apparatuses with communication functions and computing functions, of which examples will be described below. FIG. 2A is a block diagram of a client apparatus according to an embodiment of the disclosure. FIG. 2B is a block diagram of a display apparatus according to an embodiment of the disclosure.

In FIG. 2A, the client apparatus 110 is a smart phone or a smart tablet, for example. The client apparatus 110 includes a processor 201, communication equipment 203, storage equipment 205, a display 207, and an image capturing device 209. The processor 201 is coupled to the communication equipment 203, the storage equipment 205, the display 207, and the image capturing device 209. At least one of the communication equipment 203, the storage equipment 205, the display 207, and the image capturing device 209 is driven and controlled by the processor 201. In other embodiments, the image capturing device 209 may also be a non-essential component.

The processor 201 is a central processing unit (CPU), a physics processing unit (PPU), a programmable microprocessor, an embedded control chip, a digital signal processor (DSP), an application specific integrated circuit (ASIC), or other similar devices, for example.

For the communication equipment 203, a chip or a circuit supporting LAN technology, WLAN technology, or the like may be adopted. The LAN is Ethernet, for example. The WLAN is Wi-Fi, for example.

The storage equipment 205 is any form of fixed or removable random access memory (RAM), read-only memory (ROM), flash memory, a secure digital card, a hard disk drive, or other similar devices or a combination of these devices, for example. The storage equipment 205 stores at least one programming code snippet. After being installed, the programming code snippet may be executed by the processor 201.

The display 207 is a liquid crystal display (LCD), a light-emitting diode (LED) display, a plasma display, or a touch screen, for example.

The image capturing device 209 may be a video camera, a photographic camera, or the like, which adopts a charge coupled device (CCD) lens or a complementary metal oxide semiconductor transistor (CMOS) lens.

In FIG. 2B, the display apparatus 120 includes a processor 221, communication equipment 223, storage equipment 225, and a display module 227. At least one of the communication equipment 223, the storage equipment 225, and the display module 227 is driven and controlled by the processor 221. For example, the display apparatus 120 is a projector or an electronic device with a display panel, such as an LCD TV or a display. When a projector is adopted as the display apparatus 120, the display module 227 may project an image onto a wall or a projection screen. When a projector is adopted as the display apparatus 120, the display module 227 of the projector includes a light source, a plurality of optical lens elements, and a light valve for projecting an image. When other electronic devices with a display panel are adopted as the display apparatus 120, the display module 227 is a display panel such as a LCD, an LED display, or a plasma display, for example.

The processor 221, the communication equipment 223, and the storage equipment 225 of the display apparatus 120 and the processor 201, the communication equipment 203, and the storage equipment 205 of the client apparatus 110 have the same or similar functions. Accordingly, the specific realization of the processor 221, the communication equipment 223, and the storage equipment 225 of the display apparatus 120 may be designed with reference to the processor 201, the communication equipment 203, and the storage equipment 205 of the client apparatus 110, which will not be repeatedly described here.

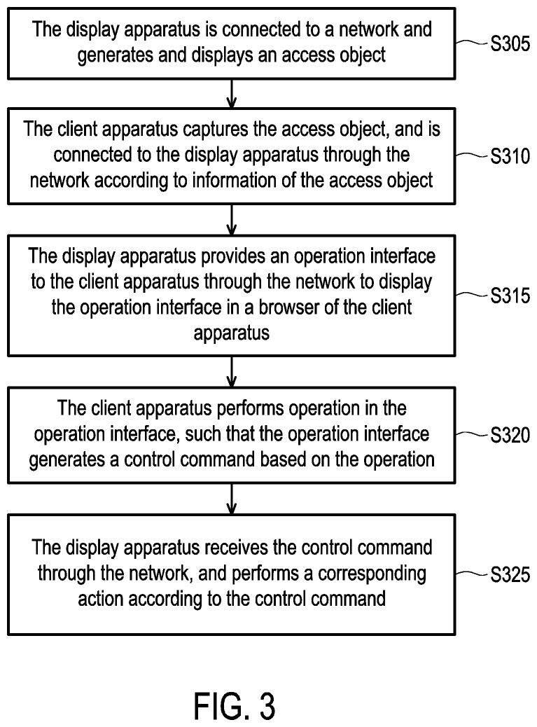

FIG. 3 is a flowchart of a control method according to an embodiment of the disclosure. With reference to FIG. 1 to FIG. 3, in step S305, the display apparatus 120 is turned on, and the display apparatus 120 is connected to a network and generates and displays an access object. Specifically, in the display apparatus 120, after being connected to the network by the communication equipment 223, the processor 221 generates the access object, and further displays the access object by the display module 227. For example, the access object is a client access address, such as a uniform resource locator (URL), or a two-dimensional code including the client access address, such as a quick response (QR) code.

In an embodiment, the display apparatus 120 is designed to: display the access object by the display module 227 in response to determining that the display apparatus 120 is connected to the network; stop displaying the access object and invalidate the client access address in response to determining that the display apparatus 120 is disconnected from the network. In other words, the display apparatus 120 may generate and provide the access object only in the state of being connected to the network. Once the connection of the display apparatus 120 is disconnected, the access object may be invalidated immediately.

Next, in step S310, the client apparatus 110 captures the access object, and is connected to the display apparatus 120 through the network according to information of the access object. In an embodiment, the client apparatus 110 may capture the access object presented by the display module 227 by the image capturing device 209. In another embodiment, it is also possible that the client apparatus 110 is not provided with the image capturing device 209, and inputs the client access address (the access object) by utilizing the display 207 provided with a touch panel. Alternatively, the client apparatus 110 may also receive the client access address by other devices with communication functions.

For example, when the display apparatus 120 is to be remotely controlled by the client apparatus 110, the client apparatus 110 utilizes the image capturing device 209 to scan the access object (e.g., a two-dimensional code) generated by the display apparatus 120, or directly inputs the client access address in a browser of the client apparatus 110.

After the client apparatus 110 accesses the display apparatus 120 through the access object, in step S315, the display apparatus 120 provides an operation interface to the client apparatus 110 through the network to display the operation interface in the browser of the client apparatus 110. For example, connection is established between the client apparatus 110 and the display apparatus 120 by WebSocket communication technology, such that the client apparatus 110 may access the operation interface provided by the display apparatus 120 by the browser of the client apparatus 110. The operation interface has a plurality of virtual keys, for example, for controlling the switching, brightness, or other functions of the display apparatus 120. Further, the access object represents the operation interface that controls the display apparatus.

Next, in step S320, the client apparatus 110 performs operation on the operation interface, such that the operation interface generates a control command based on the operation. According to the operation performed by a user in the operation interface, the client apparatus 110 may transmit the corresponding control command to the display apparatus 120 by WebSocket communication technology.

After that, in step S325, the display apparatus 120 receives the control command generated by the operation interface through the network, and the display apparatus 120 performs an action according to the control command. The display apparatus 120 parses the control command after receiving the control command, and performs the corresponding action according to the parsing result. Accordingly, the action of the client apparatus 110 remotely controlling the display apparatus 120 is realized.

Any terminal device that has a browser and supports transmission control protocol (TCP) may perform control operation by directly accessing the client access address created by the display apparatus 120.

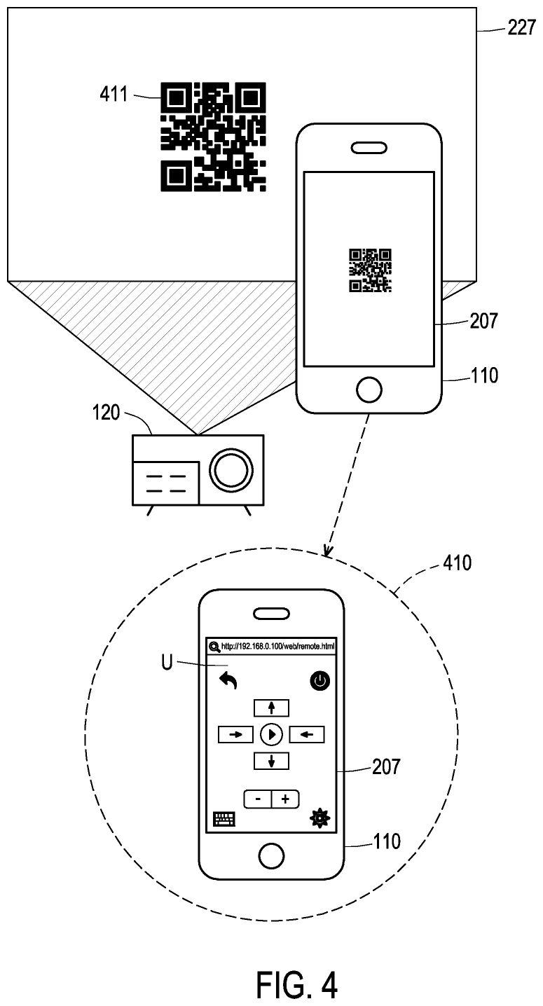

FIG. 4 to FIG. 6 are taken to respectively illustrate different application examples of remote control realized by the client apparatus 110.

FIG. 4 is a schematic diagram of the first application example of control realized by the client apparatus according to an embodiment of the disclosure. In this embodiment, the client apparatus 110 and the display apparatus 120 are respectively realized by a smart terminal device and a projector, and the display module 227 of the display apparatus 120 projects an image. In addition, a two-dimensional code 411 is taken as the access object. Here, the two-dimensional code 411 is, for example, a QR code.

First, after the display apparatus 120 is connected to the network, the display apparatus 120 by the display module 227 projects the two-dimensional code 411 onto a wall or a projection screen. Next, the client apparatus 110 drives the image capturing device 209 to scan the two-dimensional code 411 projected by the display module 227. At this time, after the client apparatus 110 scans the two-dimensional code 411, as shown in a state 410 in the figure, the client apparatus 110 may launch the browser, such that the screen of the display 207 switches to the browser to display an operation interface U for the user to operate in the operation interface of the client apparatus 110.

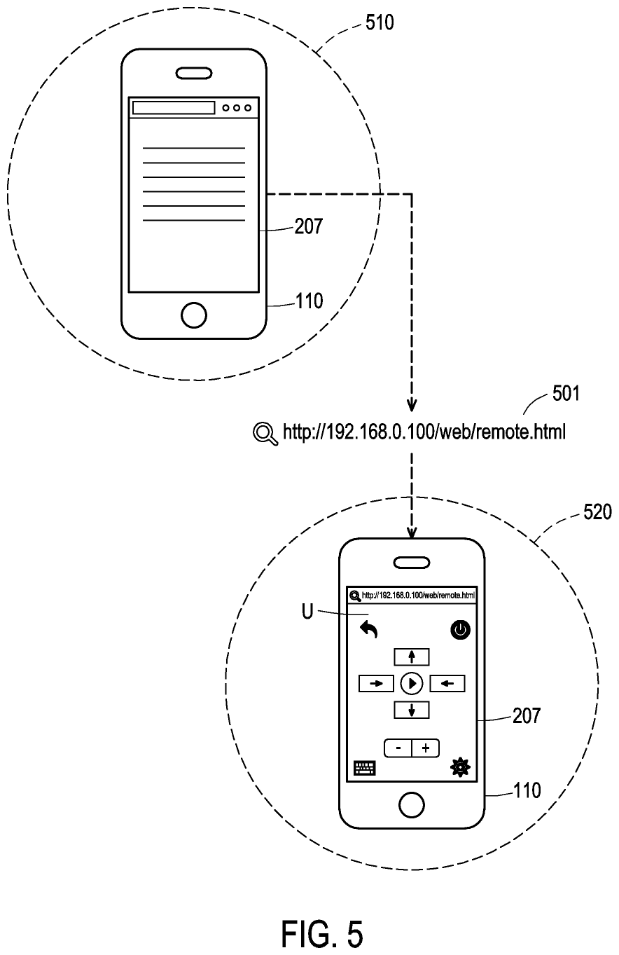

FIG. 5 is a schematic diagram of the second application example of control realized by the client apparatus according to an embodiment of the disclosure. In this embodiment, in a state 510, the client apparatus 110 directly displays the browser on the display 207 (for the user to input a client access address 501 to the client apparatus 110) to receive the client access address 501 by the browser. Next, as shown in a state 520, the client apparatus 110 accesses the operation interface U provided by the display apparatus 120 in the display 207 by the browser based on the client access address 501 for the user to operate in the operation interface of the client apparatus 110.

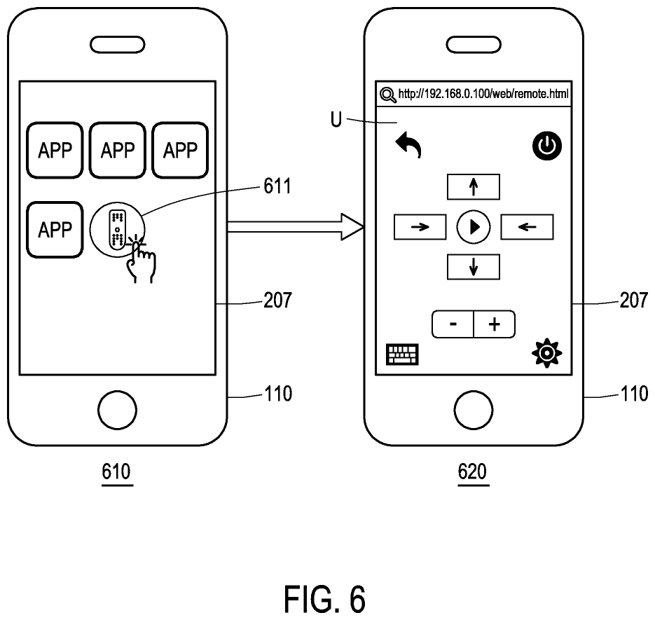

FIG. 6 is a schematic diagram of the third application example of control realized by the client apparatus according to an embodiment of the disclosure. In this embodiment, for convenience in the user's next time of use, after the operation interface U provided by the display apparatus 120 is accessed by the first application example shown in FIG. 4 or the second application example shown in FIG. 5, a shortcut icon 611 corresponding to the client access address 501 (shown in FIG. 5) may be set on the display desktop of the client apparatus 110, as shown in a state 610. When it is later intended to use the remote control function by the client apparatus 110, the shortcut icon 611 in the client apparatus 110 may be directly clicked to quickly access the operation interface U provided by the display apparatus 120 by the browser, as shown in a state 620. The premise of implementing the third application example is that the client access address 501 does not change.

In addition, in another embodiment, it is also possible that the shortcut icon is not created, while the client access address 501 (shown in FIG. 5) is saved to bookmarks or favorites.

Next, examples are provided below to describe detailed internal actions of the display apparatus 120 and the client apparatus 110.

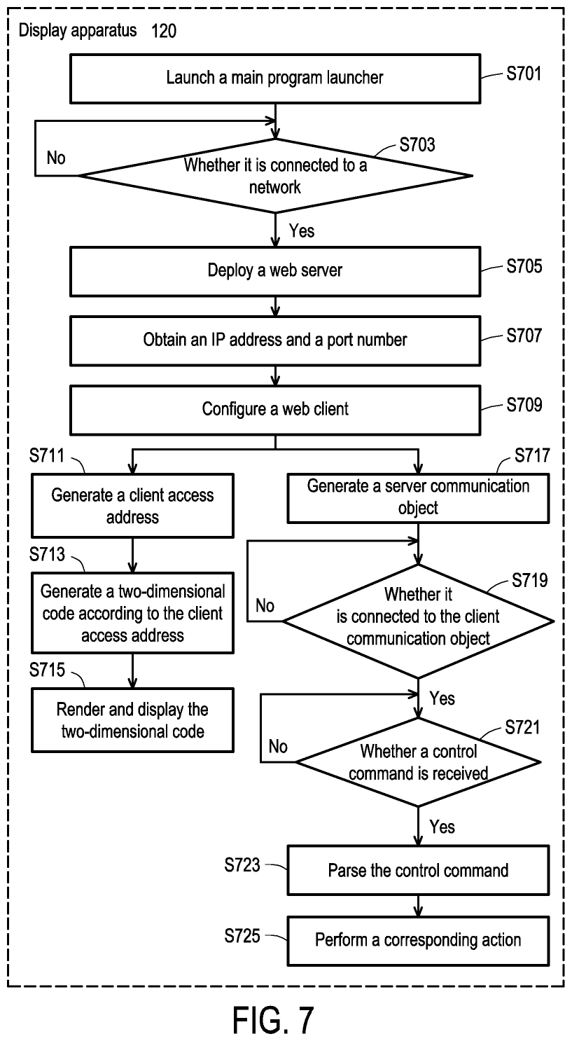

FIG. 7 is a flowchart of the detailed internal actions of the display apparatus according to an embodiment of the disclosure. With reference to FIG. 7, in step S701, in the display apparatus 120, a main program launcher is launched. Next, in step S703, it is determined whether the display apparatus 120 is connected to a network. The subsequent steps are performed after the display apparatus 120 is connected to a network. In early-stage development, developers import packaged code blocks and Java Archive (Jar) file packages into the main program launcher, modify some command parameters according to configuration document files and model features, and compile. Accordingly, the main program launcher may be transplanted to other display apparatuses without further additional development.

After the display apparatus 120 is connected to the network, in step S705, the processor 221 deploys a web server. Taking an Android system as an example, following the launch of the main program launcher, the processor 221 runs the web server in a sub-thread mode, controls the launch and shutdown of the web server according to the connection state of the network, and monitors an Internet Protocol (IP) address and a port. In the meantime, the processor 221 sets the time period of connection timeout, Secure Sockets Layer (SSL), and state monitoring, among other settings. In addition, the disclosure is also applicable to an iOS system.

Next, in step S707, a current IP address and a current port number of the display apparatus 120 are obtained by the web server. Furthermore, in step S709, a web client is configured by the web server. In an embodiment, the web client is written in HyperText Markup Language (HTML), Cascading Style Sheets (CSS), and JavaScript languages. The web client may be accessed by various web browsers, or the web client may be accessed by programs written in HTML, CSS, and JavaScript languages that have the same functions with web browsers.

After that, in step S711, the web server generates a client access address based on the IP address and the port number. The client access address is configured by the web server and stored in the display apparatus 120, which prevents being rewritten by the user of the client apparatus 110. The client access address may be directly accessible for the browser of the client apparatus 110 through the Internet. For example, it is assumed that an IP address “192.168.0.100” and a port number “:8080” are obtained according to the current network state. According to the current IP address and the current port number in combination with a static address (e.g., “/web/remote.html”), the web server automatically generates a client access address that may be accessible for the client apparatus 110, namely “http://192.168.0.100:8080/web/remote.html”.

In step S713, the processor 221 generates a two-dimensional code according to the client access address to take the two-dimensional code as the access object. For example, the processor 221 converts the client access address from a string into the two-dimensional code by programming. After that, in step S715, the processor 221 renders and displays the two-dimensional code. In other embodiments, the client access address may also be directly displayed as the access object by the display module 227. The two-dimensional codes generated according to different IP addresses or different port numbers are different.

In an embodiment, the web server is provided with a monitoring program for network state changes. When the network is disconnected, the web server stops running, the two-dimensional code disappears automatically, and the client access address is likewise invalidated. When connection to the network is restored, the web server restarts automatically and generate the two-dimensional code based on the steps above.

In addition, after obtaining the IP address and the port number, in step S717, the web server generates a server communication object based on the current IP address and the current port number of the display apparatus 120. In this embodiment, communication between the client apparatus 110 and the display apparatus 120 through the network requires a pair of communication objects. The communication object running on the web server is referred to as a server communication object, and the communication object running on the web client is referred to as a client communication object. In the WebSocket communication technology, ServerSocket is a server communication object, and ClientSocket is a client communication object.

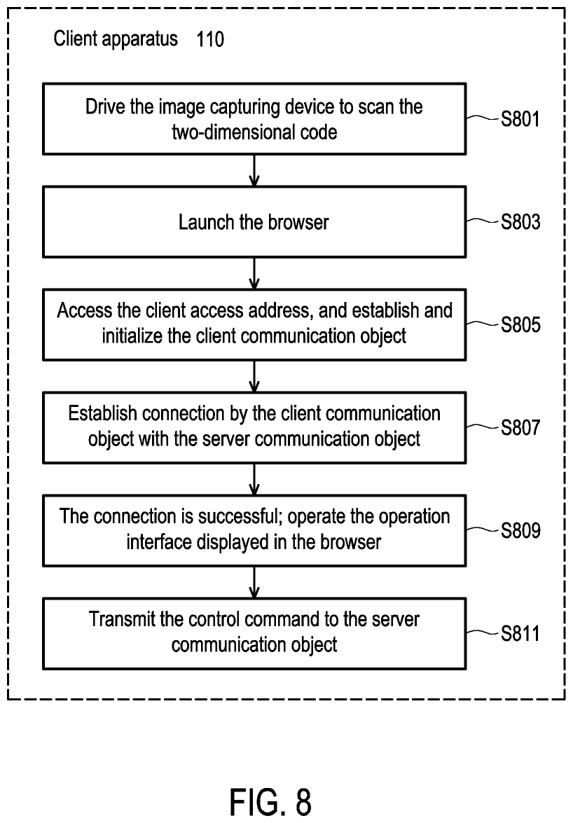

Based on the IP address and the port number, the web server generates a communication server process and is bound to the Socket of the web server to generate ServerSocket (i.e., the server communication object). Comparatively, ClientSocket (the client communication object) is created and initialized when the client apparatus 110 accesses the operation interface by the browser (refer may be made to step S805 of FIG. 8 below).

In step S719, the server communication object determined whether it is connected to the client communication object, and proceeds with subsequent execution after determining it is connected to the client communication object.

After the server communication object is connected to the client communication object, in step S721, the server communication object determines whether a control command is received from the client communication object, and proceeds with subsequent execution after the control command is received.

After the control command is received, in step S723, the control command is parsed by the web server. After that, in step S725, a corresponding action is performed by the web server.

Taking the display apparatus 120 realized by a projector for description, it is assumed that the projector adopts an Android system or an iOS system. The corresponding action performed by the web server is to call the command “adb shell input”. Actions related to the command “adb shell input” include “text” (to simulate input text), “keyevent” (to simulate key press), “tap” (to simulate screen tapping), and “swipe” (to simulate screen swiping). For example, the command “adb shell input keyevent 4” corresponds to the return (back) operation of the keyboard, and the command “adb shell input keyevent 66” corresponds to the confirm (enter) action of the keyboard. Since the web server established by the Android system of the projector cannot directly call the command operation of the system, the system function “Runtime.getRuntime( )exec( ) is required to be used during programming to perform the corresponding action. For example, “Runtime.getRuntime( )exec(”input keyevent 4″)” is used to perform the return operation.

In addition, realization of complex commands also requires serial communication between the Android system and a digital display processor (DDP) of the projector. After the related actions is parsed from the command, the control command data is sent to the DDP by the serial port. In an embodiment, the control command uses the hexadecimal HEX code. After control command is successfully parsed, the type of the control command is determined by matching with the command list. If the type of the control command is an Android system command, the corresponding action is performed by the Android system. If the type of the control command is a DDP command, the control command is transmitted to the DDP by the serial port, such that the corresponding action is performed by the DDP.

Since the web server created by the display apparatus 120 is a local server, there is no need to rely on an external network server device, and the display apparatus 120 may also realize access control operations when there is no access to an external network. In addition, the web server created by the display apparatus 120 acquires the system service permission to ensure long-time running of background works without stopping. Even if the display apparatus 120 is turned off, the web server may also be turned on automatically after the display apparatus 120 restarts. The monitoring state of Socket is maintained throughout. At any time period, the control command from the client apparatus 110 may be received and the corresponding action may be performed accordingly.

In another embodiment, if the display apparatus 120 sets the number of allowable connections to multiple connections or does not to limit the number of connections, multiple client apparatuses may access the same display apparatus 120 at the same time. The steps of controlling by each client apparatus are the same as those described in the embodiments above. The display apparatus 120 performs corresponding actions according to the sequence of receiving control commands.

FIG. 8 is a flowchart of the detailed internal actions of the client apparatus according to an embodiment of the disclosure. With reference to FIG. 8, in step S801, the client apparatus 110 drives the image capturing device 209 to scan the two-dimensional code. Next, in step S803, the browser is launched. After that, in step S805, the client access address is accessed, and the client communication object is established and initialized. In other words, after scanning the two-dimensional code and parsing out the client access address in the two-dimensional code, the client apparatus 110 automatically switches to the browser to access the client access address. When the client access address is accessed, the client communication object is established and initialized.

Next, in step S807, connection is established by the client communication object with the server communication object. For example, to create WebSocket connection, in the client apparatus 110, the browser sends a connection request by ClientSocket, and then ServerSocket responds, which confirms connection established and bidirectional communication maintained between the two parties.

In step S809, the connection is successful, and the operation interface displayed in the browser is operated by the client apparatus 110. After that, in step S811, the client apparatus 110 transmits the control command by the client communication object to the server communication object.

In another embodiment, one client apparatus 110 may remotely control multiple arbitrary display apparatuses. In other words, when multiple display apparatuses are connected to the network where the client apparatus 110 is located, if it is intended to realize one client apparatus 110 remote controlling multiple display apparatuses, it is only required to switch between the client access addresses to be accessed by the browser.

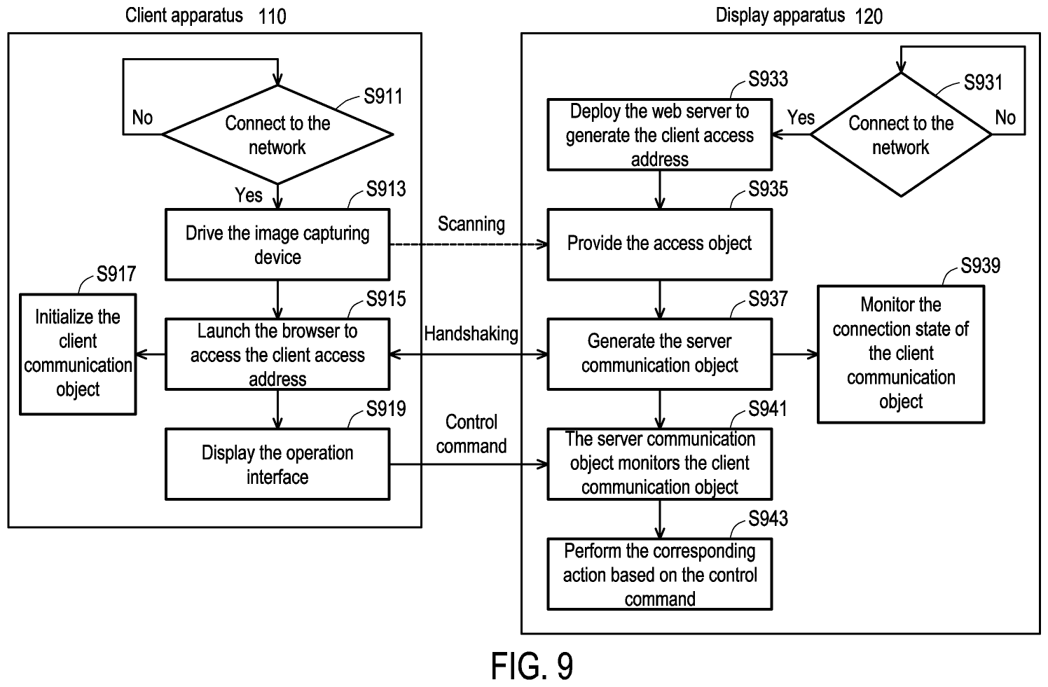

FIG. 9 is a flowchart of interactions between the client apparatus and the display apparatus according to an embodiment of the disclosure. FIG. 9 integrates interactions between the two parties of FIG. 7 and FIG. 8. With reference to FIG. 9, in step S911, the processor 201 of the client apparatus 110 may determine whether it is connected to the network by the communication equipment 203, and performs the subsequent steps after it is connected to the network. Similarly, in step S931, the processor 221 of the display apparatus 120 may determine whether it is connected to the network by the communication equipment 223, and performs the subsequent steps after it is connected to the network.

After the display apparatus 120 is connected to the network, in step S933, the processor 221 deploys the web server to generate the client access address (reference may be made to steps S705, S707, and S711). Next, in step S935, the processor 221 provides the access object (reference may be made to steps S713 and S715), namely displays the access object by the display module. After the display apparatus 120 deploys the web server, in step S937, the server communication object is generated by the web server. Furthermore, in step S939, the connection state of the client communication object is monitored by the server communication object.

After the access object is displayed by the display module 227, in step S913, the processor 201 of the client apparatus 110 drives the image capturing device 209 to scan the access object displayed by the display module 227. In step S915, the client apparatus 110 launches the browser to access the client access address. Furthermore, in step S917, the client communication object is initialized. After the client apparatus 110 obtains the client access address based on the access object, the client apparatus 110 automatically switches to the browser to access the client access address, and establishes and initializes the client communication object in the meantime.

The client apparatus 110 and the display apparatus 120 establish bidirectional transmission by the client communication object and the server communication object. In the WebSocket communication technology, it is only required to complete handshaking once between the client apparatus 110 and the display apparatus 120, and persistent connection may be established and bidirectional data transmission may be performed between them.

For example, ServerSocket (the server communication object) may monitor the connection status with ClientSocket (the client communication object). ServerSocket determines whether a connection request is received from ClientSocket. If ServerSocket does not receive a connection request from ClientSocket, ServerSocket enters a blocking state. If ServerSocket receives a connection request from ClientSocket, ServerSocket may establish a new thread to connect ClientSocket and starts performing bidirectional data transmission in response to the connection request from ClientSocket.

After connection is established between the two parties, in step S919, the operation interface is displayed in the browser of the client apparatus 110, such that the user of the client apparatus 110 can operate in the operation interface and transmit the control command to the display apparatus 120.

In the display apparatus 120, in step S941, the client communication object is monitored by the server communication object to determine whether the control command is received. After the control command is received, in step S943, the corresponding action is performed based on the control command (reference may be made to steps S723 and S725).

During the process where the user utilizes the client apparatus 110 to operate the operation interface provided by the display apparatus 120, at the time of closing the page or exiting the browser, the connection between the client apparatus 110 and the display apparatus 120 is also closed immediately without specific closing or exiting action. Then next time when the client apparatus 110 accesses the operation interface provided by the display apparatus 120, the connection between the client apparatus 110 and the display apparatus 120 may be automatically initialized and connected to continue the remote control operation.

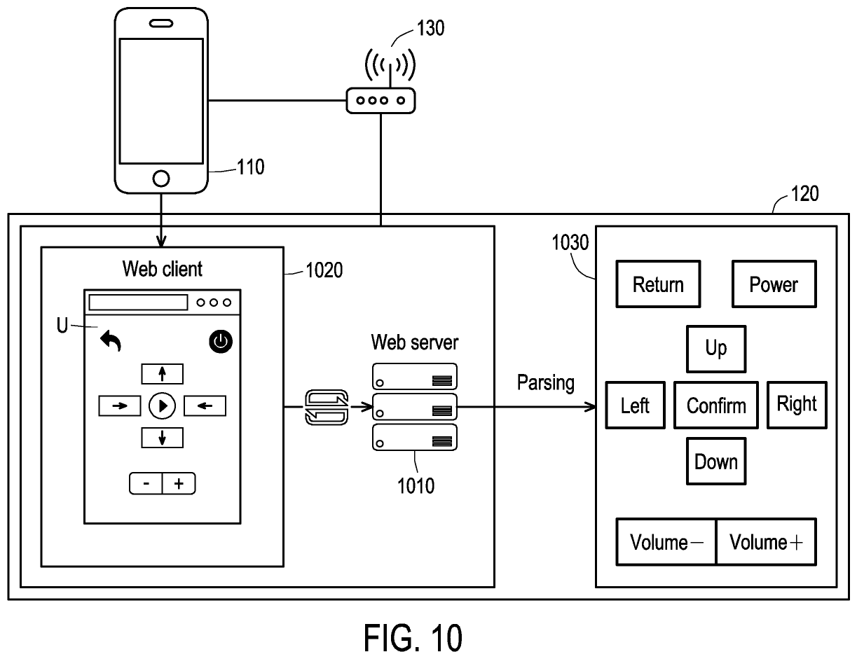

FIG. 10 is a schematic diagram of overall actions of a control system according to an embodiment of the disclosure. With reference to FIG. 10, the display apparatus 120 deploys a web server 1010, and a web client 1020 is configured by the web server 1010 to provide the operation interface U by the web client 1020. The display apparatus 120 also includes a command library 1030. The command library 1030 stores the corresponding relationship between multiple control commands and corresponding specific actions to be performed.

The user accesses the client access address by the browser of the client apparatus 110 to access the web client 1020. At this time, the operation interface U provided by the web client 1020 may be displayed in the browser of the client apparatus 110. The client apparatus 110 performs operation on the operation interface U on the browser of the client apparatus 110, such that the operation interface U generates the control command. After receiving the control command, the web server 1010 parses the control command and compares with the specific actions in the command library 1030 based on the parsing result to perform the corresponding action.

The web server 1010 and the web client 1020 adopt HTTP. It is only required to complete handshaking once, and persistent connection may be established between them. Moreover, the data format is lightweight and the performance overhead is small. During data exchange between the web client 1020 and the web server 1010, data packet headers from the web server 1010 to the web client 1020 only have 2 to 10 bytes. An additional 4-byte mask is required to be added in the direction from the web client 1020 to the web server 1010. HTTP requires carrying full headers each time. Since the web server 1010 and the web client 1020 adopt HTTP, better binary support is achieved, text and binary data may be transmitted, and the web server 1010 responds quickly.

In summary of the foregoing, in the embodiments of the disclosure, with the access object provided by the display apparatus, the client apparatus can directly access the operation interface provided by the display apparatus. The client apparatus operated by the user is only in charge of transmitting the control command, and other specific operations are performed by the display apparatus. Accordingly, command development for the display apparatus may be made with relatively great freedom based on the firmware of the display apparatus, and the display apparatus may execute the application programming interface (API) in combination with command scripts according to the actions opened by different working units to perform more complex operations of common settings. It is not required to switch to the configuration interface to be modified step by step according to the option menu to then perform modification and adjustment.

Accordingly, the embodiments of the disclosure disclose that the user may be provided with more options to control the display apparatus, effectively substituting for the conventional remote control. Furthermore, by setting the shortcut icon in the client apparatus, the number of actions to be performed can be reduced. In the embodiments of the disclosure, it is also not required to install specific APPs in the client apparatus, and only the built-in browser in the client apparatus is required to realize the control. Compared with the development of the existing smart remote control, the disclosure significantly reduces the development difficulty and cost, and only requires development directed to the display apparatus end.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure” does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the present disclosure is intended to be dedicated to the public regardless of whether the element or component is explicitly recited in the following claims.

What is claimed is:

1. A control system comprising:
a display apparatus, connected to a network, and configured to generate and display an access object; and
a client apparatus, connected to the network, having a browser, and configured to capture the access object and connect to the display apparatus through the network according to information of the access object, wherein
the display apparatus is configured to provide an operation interface to the client apparatus through the network to display the operation interface in the browser of the client apparatus; wherein a control command is generated according to operation in the operation interface and the control command is transmitted to the display apparatus through the network, the display apparatus is configured to perform an action according to the control command.

2. The control system according to claim 1, wherein the display apparatus, after being connected to the network, is configured to:
deploy a web server;
obtain a current Internet Protocol (IP) address and a current port number of the display apparatus by the web server, and generate a client access address by the web server based on the current IP address and the current port number;
generate a two-dimensional code based on the client access address to take the two-dimensional code as the access object; and
display the two-dimensional code by a display module of the display apparatus.

3. The control system according to claim 2, wherein the client apparatus is configured to:
drive an image capturing device to scan the two-dimensional code displayed by the display module to launch the browser; and
access the client access address by the browser to display the operation interface in the browser.

4. The control system according to claim 1, wherein the display apparatus is configured to:
deploy a web server after determining that the display apparatus is connected to the network;
obtain a current IP address and a current port number of the display apparatus by the web server, and generate a client access address by the web server based on the current IP address and the current port number to take the client access address as the access object; and
provide and display the client access address by a display module of the display apparatus.

5. The control system according to claim 4, wherein the client apparatus is configured to:
obtain the client access address by the browser, and access the client access address by the browser to display the operation interface in the browser.

6. The control system according to claim 1, wherein
a display module of the display apparatus displays the access object in response to determining that the display apparatus is connected to the network, wherein the access object comprises a client access address; and
the display module of the display apparatus stops displaying the access object and the client access address is invalidated in response to determining that the display apparatus is disconnected from the network.

7. The control system according to claim 1, wherein the display apparatus is configured to deploy a web server after being connected to the network, and the display apparatus:
by the web server, generates a server communication object based on a current IP address and a current port number of the display apparatus, and generates a client access address based on the current IP address and the current port number of the display apparatus,
wherein the client apparatus is configured to: establish and initialize a client communication object in response to accessing the client access address based on the access object, and
the client apparatus performs data transmission by the client communication object with the server communication object of the display apparatus.

8. A control method adapted to control a display apparatus by a client apparatus, the control method comprising:
by the display apparatus, connecting to a network and generating and displaying an access object;
by the client apparatus, capturing the access object and connecting to the display apparatus through the network according to information of the access object;
providing an operation interface by the display apparatus through the network to the client apparatus to display the operation interface in a browser of the client apparatus;
performing operation on the operation interface by the client apparatus, such that the operation interface generates a control command based on the operation; and
by the display apparatus through the network, receiving the control command and performing an action of the display apparatus according to the control command.

9. The control method according to claim 8, wherein, after connecting to the network by the display apparatus, the method further comprises:
deploying a web server by the display apparatus;
obtaining a current Internet Protocol (IP) address and a current port number of the display apparatus by the web server and generating a client access address by the web server based on the current IP address and the current port number;
generating a two-dimensional code by the display apparatus based on the client access address to take the two-dimensional code as the access object; and
providing and displaying the two-dimensional code by a display module of the display apparatus.

10. The control method according to claim 9, wherein capturing the access object and connecting to the display apparatus through the network according to the information of the access object by the client apparatus comprises:
driving an image capturing device to scan the two-dimensional code on the display module by the client apparatus;
launching the browser by the client apparatus; and
accessing the client access address by the browser through the network, such that the display apparatus provides the operation interface to the browser.

11. The control method according to claim 8, wherein, after connecting to the network by the display apparatus, the method further comprises:
deploying a web server by the display apparatus;
obtaining a current IP address and a current port number of the display apparatus by the web server, and generating a client access address by the web server based on the current IP address and the current port number to take the client access address as the access object; and
providing and displaying the client access address by a display module of the display apparatus.

12. The control method according to claim 11, wherein capturing the access object and connecting to the display apparatus through the network according to the information of the access object by the client apparatus comprises:
launching the browser by the client apparatus to obtain the client access address by the browser, and accessing the client access address by the browser through the network to display the operation interface in the browser.

13. The control method according to claim 8, further comprising:
displaying the access object by a display module of the display apparatus in response to determining that the display apparatus is connected to the network, wherein the access object comprises a client access address; and
in response to determining that the display apparatus is disconnected from the network, stopping displaying the access object by the display module of the display apparatus, and invalidating the client access address.

14. The control method according to claim 8, wherein, after connecting to the network by the display apparatus, the method further comprises:
deploying a web server by the display apparatus, and
by the web server:
generating a server communication object based on a current IP address and a current port number of the display apparatus; and
generating a client access address based on the current IP address and the current port number of the display apparatus,
and wherein, after capturing the access object by the client apparatus, the method further comprises:
accessing the client access address by the client apparatus through the network according to the access object; and
establishing and initializing a client communication object by the client apparatus, wherein the client apparatus performs data transmission by the client communication object with the server communication object of the display apparatus.

15. A display apparatus comprising:
communication equipment configured to be connected to the network; and
a processor coupled to the communication equipment, the processor configured to:
connect to a network by the communication equipment, and generate and display an access object representing an operation interface controlling the display apparatus; and
receive a control command generated according to operation in the operation interface, and perform an action of the display apparatus according to the control command.
